(19) United States
(12) Patent Application Publication
(10) Pub. No.: US 2026/0197354 A1
(43) Pub. Date: Jul. 9, 2026

(54) AUTOMATED PROVISIONING OF ADAPTED CYBERSECURITY POLICY SETS

(71) Applicant: Dell Products L.P., Round Rock, TX (US)

(72) Inventors: Thais Luca Marques de Almeida, São Gonçalo (BR); Vítor Nascimento Lourenço, Niterói (BR); Werner Spolidoro Freund, Rio de Janeiro (BR); Roberto Nery Stelling Neto, Rio de Janeiro (BR); Fabricio Matheus Takaki, Valinhos (BR); Vicente J.P. Amorim, João Monlevade (BR)

(21) Appl. No.: 19/012,743

(22) Filed: Jan. 7, 2025

(51) Int. Cl. H04L 9/40; H04L 41/14

(52) U.S. Cl. CPC H04L 63/205; H04L 41/145

(57) ABSTRACT

One example method implements a policy hot-start in an environment, and the method includes receiving, as input, respective descriptions of reference environments, a respective set of reference operating policies for each of the reference environments, and a description of a target environment, using respective graphs to represent each of the reference environments, normalizing the reference operating policies in a normalized description form in which alignment operations can be applied, mapping from the reference environments to a target environment by applying a graph alignment technique to the graphs, and automatically generating a set of policies compatible with the description of the target environment by mapping the reference policies to the target environment.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to cybersecurity. More particularly, at least some embodiments relate to systems, hardware, software, computer-readable media, and methods, for generation of cybersecurity policy sets for environments.

### BACKGROUND

Access policies are paramount for cybersecurity environments to deal with increasingly sophisticated cyber threats. Such policies define rules that are responsible for grating or denying access to a given resource. Obtaining an efficient operational set of initial policies is particularly challenging since organizations transitioning to new architectures are not used to the intrinsic operational details of the new architecture. Even for experts aware of new architecture design details, the process of defining an initial set of policies from scratch is time-consuming which hinders the migration process. The policy cold-start problem may refer to the challenge of deriving an initial set of compliant policies to determine controls of some kind in an architecture. Current approaches are mainly manual and not able to handle the complexities of large environments that have inventories and policies in numbers that make it impossible for a human to perform policy provisioning as a manual process.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a workflow, according to one embodiment.

FIG. 2 discloses aspects of an example description of an environment, according to one embodiment.

FIG. 3 discloses an example of a JSON (JavaScript Object Notation) file structure representing a potential input graph, according to one embodiment.

FIG. 4 discloses an example depicting ontology reasoning features, according to one embodiment.

FIG. 5 discloses some high-level processing steps of a Hot-Start Engine, according to one embodiment.

FIG. 6 discloses an example algorithm for generating initial policies, provided a set of policies from input ZTA environments, according to one embodiment.

FIG. 7 discloses aspects of a high-level workflow of a system, according to one embodiment.

FIG. 8 discloses an operational ZTA environment description (left side) and the description of a new ZTA environment to derive policies (right side), according to one embodiment.

FIG. 9 discloses an implemented set of policies in a first company which has a properly built ZTA environment that is to be adapted in a second company, according to one embodiment.

FIG. 10 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to cybersecurity. More particularly, at least some embodiments relate to systems, hardware, software, computer-readable media, and methods, for generation of cybersecurity policy sets for new and modified environments.

One or more example embodiments comprise a method and/or architecture that generate a policy set, comprising one or more policies, for a new or modified environment. One example environment comprises a computer network, such as may be implemented by a business entity for example. This is provided only for illustrative purposes however, and the scope of this disclosure, and of any claims, is not limited to this example.

One example method according to an embodiment may comprise operations including: receiving, as input, a set of reference environments containing their descriptions, their set of reference operating policies, and a description of a target environment; using Knowledge Graphs (KG) to obtain up-to-date and precise representation of the reference environments; using First-order Logic (FOL) to make reference to operating policies human-readable; mapping from the reference environments to a target environment using a graph alignment technique; and, automatically generating a set of policies compatible with the target environment description by mapping the reference policies (logical rules) to the target environment domain (as appliable).

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may, through the use of an automated process for policy set generation, overcome the inability to manually generate new policy sets for a new environment—this functionality of an embodiment may be particularly useful in circumstances where new and modified environments are being created continuously and new policies are needed to be generated in real time as new and modified environments come online. An embodiment may reduce, or eliminate, errors that would otherwise occur in manual generation of policy sets. An embodiment may enable testing of a target environment, using policies generated by an automated process according to an embodiment, to ensure the policies are adequate for the target environment. Various other advantages of one or more example embodiments will be apparent from this disclosure.

### A. REFERENCES

Reference is made herein to various documents, which are listed below. These documents are incorporate herein in their respective entireties by this reference.
[1] P. a. T. S. Phiayura, “A Comprehensive Framework for Migrating to Zero Trust Architecture,” IEEE Access, vol. 11, no. IEEE, pp. 19487-19511, 2023.
[2] Y. He, D. Huang, L. Chen, Y. Ni e X. Ma, “A survey on zero trust architecture: Challenges and future trends,” Wireless Communications and Mobile Computing, 2022.
[3] I. Bratko, “Prolog,” Programming for Artificial Intelligence (Second Edition ed.), 1990.
[4] Kurniawan, K., Ekelhart, A., Kiesling, E., Quirchmayr, G., Tjoa, A. M., 2022. KRYSTAL: Knowledge graph-based framework for tactical attack discovery in audit data. Computers & Security 121, 102828.

### B. OVERVIEW OF ASPECTS OF ONE OR MORE EMBODIMENTS

One or more embodiments may mitigate the cold-start problem by providing a mechanism able to map previously defined policies from known environments into an initial set of policies to a new environment. The cold-start problem refers to the circumstance in which a set of security policies is needed to be generated for a target environment, that may comprise a new or modified environment. A variety of challenges, which may be overcome by one or more embodiments, may be involved in generating such a set of security policies, including:
Parsing descriptions of reference environments to obtain an up-to-date, complete, and precise representation of the network.
Obtaining policy representations to provide human-readable, and easy to understand rules, that may be verifiable by a specialist.
Providing a policy mapping method so that it is possible to take advantage of policies from well-defined environments to create an initial set of policies for a new or modified environment.
Generating new policies based on the descriptions and policies given as input by relying on the identified mappings.

Thus, one or more embodiments comprise a method that uses knowledge from existing environments to automatically generate an initial policy set to a new environment. This initial policy set may, or may not, be employed/employable out-of-the-box in a new environment. An embodiment may comprise an approach to facilitate the derivation of a set of policies for later selection, validation, and enhancement. One or more embodiments may focus particularly on the derivation of an initial policy set. However, a method according to one embodiment may be used to facilitate multiple organizations and consortiums in keeping their defensive postures in sync.

A method according to one embodiment may assume the prior existence of a set of one or more environments, each with a respective operational set of policies, and a description of its specificities. Within the context of one embodiment, the environment description is a representation of the conceptual level of its entities and their relationships. In an embodiment, it may be assumed that all policies are validated and operationalized in previous environments, such that those policies may serve as good input sources for a method according to one embodiment.

In an embodiment, a system resorts to such prior information, and a description of the new environment, to generate an initial set of policies that are aligned to the new environment. This process thus comprises a leveraging of the knowledge encoded in the policies of prior environments to suggest a set of policies to be applied in a new environment.

One example embodiment may comprise components including:
A Data Parsing Module which provides the representation of the environments' entities and relations along with the representation of the set of policies of an environment.
An Environment Alignment Module which identifies matching entities and relations across the environments with the new environment description using a Logical System, and
A Policy Generation Engine which relies on the representations provided in the Data Parsing Module to generate new policies based on the alignments identified in the Environment Alignment Module and a well-defined operational set of policies given as input.

Thus, an embodiment may comprise a framework that, given a set of reference environments containing their description, their set of operating policies and the description of a target environment, uses Knowledge Graphs (KG) to obtain up-to-date and precise representation of networks, and also uses First-order Logic (FOL) to make policies human-readable and easy to understand. An embodiment may perform mappings between environments through the usage of graph alignment techniques. An embodiment may automatically generate a set of policies compatible with the target environment description by mapping the reference policies (logical rules) to the target environment domain (whenever appliable). The target environment descriptions may be provided in any representation that can be mapped to a graph representation.

### C. DETAILED DISCUSSION

### C.1 Context for One or More Embodiments

### C.1.1 First-Order Logic (FOL)

In First-Order Logic (FOL), domains are represented by logical facts which contain predicates and terms. Objects are represented using constants, and variables are terms to be substituted by constants aiming at answering questions about how constants relate to each other. These relations are represented by predicates between objects in the domain. For instance, publication (title, jane) states that a publication named title was written by jane. In this example, the predicate is publication, and title and jane are constants representing objects in the real-world. Following Prolog (see [3]) syntax, all names of variables start with capital letters, while predicates and constants start with lower letters.

Properties of entities are represented in the corresponding graphs and can also be written as atoms:
dataScientist(Person).
productManager(Person).
hasAccess(Person, Application).
   Unary relations/predicates such as dataScientist and productManager have only one argument of type Person. hasAccess is a binary predicate that connects an entity of type Person to other entity of type Application.

Policies are represented as clauses in a logic program:
submitInvention(U,A):-dataScientist(U),hasAccess(U,A).
   Here, the left side of a clause is called the head while the right side is called the body. In this illustrative example, to submit an invention, submitInvention (U, A) states that a user U is allowed to submit an invention if U is a dataScientist and has access to the application A. Variables such as Person and Application must be replaced by constants, i.e., objects in the real-world. Thus, represent entities and relations can be represented by using logical facts:
dataScientist(thais).
productManager(vitor).
has Access(thais, anaqua).
hasAccess(vitor, anaqua).

In the example above, both dataScientist and productManager represent properties of real-world objects thais and vitor. In this case, the atom submitInvention is true for thais, given the knowledge presented above, if and only if U is replaced by thais and A by anaqua. vitor may have access to anaqua but cannot submit an invention because the environment states that only dataScientists can submit inventions.

### C.1.2 Graph Alignment

In an embodiment, a graph may be aligned using various approaches:
The first are the terminological methods, which is grounded on the comparison of terms, strings, or texts by calculating the value of similarity between units of texts-such as names, labels, and descriptions. It can be based on characteristics of such terms or on linguistic knowledge.
The second are the structural methods—the similarity between two entities is given by exploiting structural information, when they are connected to others by semantic or syntactic links, leading to a hierarchy or a graph of entities.

A simple example of the second approach, that is, the structural methods, is the algorithm proposed by [3]. Given two graphs source and target, this approach tries to find matching entities based on similarity of texts and network topology. The pre-matching phase calculates an initial similarity (Sim) between entities' labels. If an entity s in source has the same label of an entity t in target, Siml(s, t) is equal to 1.

Otherwise, a processing function is applied to both entities. The first step of such function is to split each string into its component words (for instance, chief_technology_officer is converted into “chief technology officer”). Then, all stopwords are removed and stemming is applied. Stemming reduces word to their roots: words like “writes” and “writing” are reduced to “write,” for example. An embodiment may refer to the entities after processing sp_{source}, CP_{target}, respectively. The similarity between two concepts s and t is given by:

$$Siml ( s , t ) = \frac{2 \times \vert common ( {sp}_{s o u rce} , {cp}_{target} ) \vert}{long ( {sp}_{s o u r c e} ) + long ( {cp}_{target} )} ,$$

where |common (sp_{source}, cp_{target})| is the number of common words between the source concept strings and the target concept strings. long(sp_{source}) and long(sp_{target}) denote the number of words in sp_{source} and sp_{target}, respectively.

The goal of this first step is to obtain elements that are linguistically similar. Then, the algorithm searches for structural similarities between these elements. Similarity based on network topology is given by:

$$M S {S}_{s i m ( s , t )} = p \times S i m l ( s , t ) + \frac{1 - p}{n} \sum max \{ S i m l ( {s}_{i} , {t}_{1} ) … Siml ( {s}_{i} , {t}_{m} ) \} ,$$

where n is the number of neighbors of the node s and m is the number of neighbors of node t. p is a percentage contribution parameter and is set at 0.75 by authors. An entity in graph source is mapped to an entity in target if they have the highest similarity between other pairs of concepts.

This alignment approach can be generalized to requiring that n-graphs are aligned. In the end, we have the corresponding mappings between the new environment description and the existing environments given as input. As mentioned earlier, any algorithm for graph alignment can be applied to find the corresponding mappings.

### C.2 Discussion

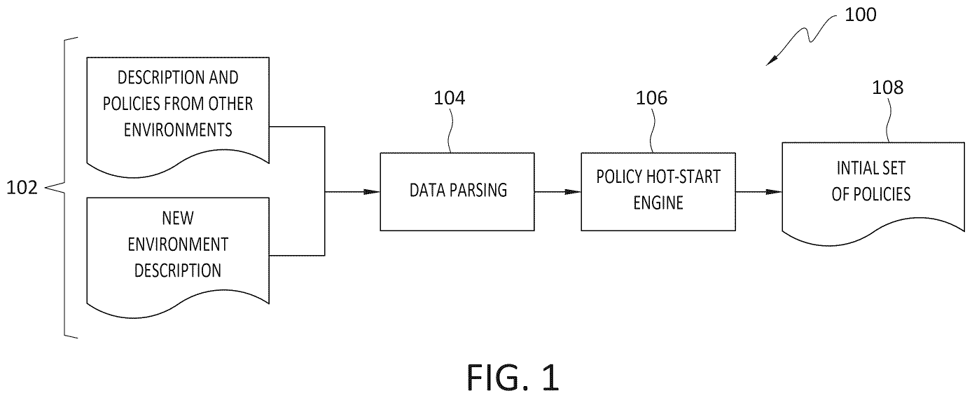

As noted earlier, one example embodiment comprises a method that leverages policies and descriptions of existing environments to mitigate the cold-start policy problem in a new environment, as depicted in FIG. 1, which discloses a high-level workflow 100 according to one embodiment. By way of overview of FIG. 1, inputs 102 comprising (1) reference environment descriptions and reference security policies from other environments, and (2) a description of a target environment may be subjected to a data parsing process 104 that may extract environment and policy information from the inputs 102. The parsed data may then be provided to a policy hot-start engine 106 that uses the parsed data to generate an initial set of policies 108. Each of these various aspects of the example workflow 100 are discussed in more detail below.

### C.2.1 Data Parsing

### C.2.1.1 Environment Description

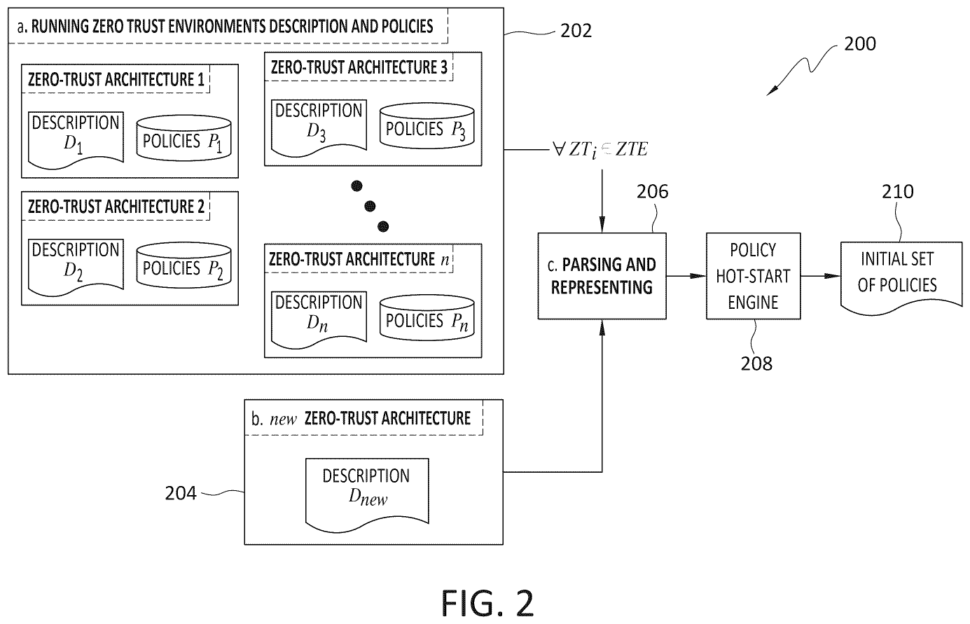

As disclosed in the example schema 200 of FIG. 2, one embodiment assumes that the system receives, as input, structured data files 202, such as JSON files, containing the environment descriptions of other known environments, also referred to herein as ‘reference’ environments, and another data file 204 comprising descriptive information concerning a target environment for which policies are to be generated. These files 202 contain the conceptual level description of every entity presented in each environment and how they relate to each other. As well, these files 202 may contain properties of such entities and their types, and how these entities may relate to each other. A system and/or workflow according to an embodiment also receives one or more files containing a set of policies, also referred to herein as ‘reference’ policies, of each environment.

With the input files 202, a system according to one embodiment may model the input data, that is, the data in the input files 202, as graphs in which each node represents an entity, and two nodes are connected by a semantic edge if they are related. Graphs can play a vital role to tackle cybersecurity requirements as they enable an up-to-date, complete, and precise representation of the network. Thus, one graph is created for each environment given as input. As shown in FIG. 2, the files 202 and 204 are provided to a parsing process 206 (see also, reference 104 in FIG. 1) which, as discussed below, outputs parsed data and representations to a policy-hot start engine 208 that operates to generate an initial set of policies 210. Aspects of an example policy-hot start engine, and initial set of policies, are discussed below.

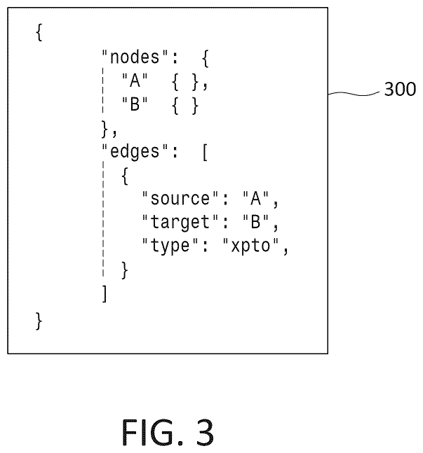

There are a variety of forms to represent entities and relationships using a structured file. Taking a JSON file as example, entities can be represented by objects using a unique identifier as key and containing some properties as values like labels or some metadata. Edges can be described as an array of objects with properties source, destination, and associated semantics type. FIG. 3 discloses one example of such a file 300. Particularly, FIG. 3 discloses an example of a JSON file 300 structure representing a potential input graph. In an embodiment, all nodes may be declared first so the system can process these files by loading nodes in memory and then creating the edges that connect the nodes.

### C.2.1.2 Policy Description and Corresponding Predicates

Polices can also be represented in many different forms, such as declarative statements, and logical rules. One example embodiment envisions policies represented using FOL as presented in the example of FIG. 9, discussed below. An embodiment may use FOL because it is an easy, natural, and human-readable way to represent rules. As well, it is easy to generalize to any new environment or entity presented in the architecture. However, any data structure can be used during collecting and replacing of rules. A possible embodiment to achieve reasoning is on top of ontologies and associated inference, such as OWL (Web Ontology Language) reasoning rules for example, features for simplicity of exposition.

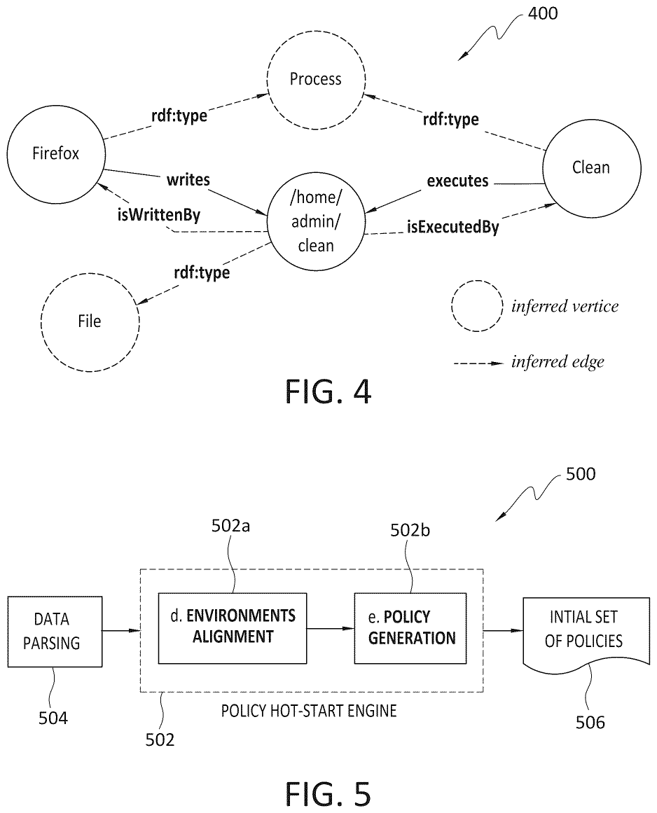

For example, suppose the following system log telemetry information is collected as depicted in the example schema 400 of FIG. 4, which discloses ontology reasoning features: [(Firefox, writes, /home/admin/clean), (Clean, executes, /home/admin/clean)]. Ontology reasoning capabilities enable the inferring and extracting of information. This example includes the following entities: file (/home/admin/clean), process (firefox), process (clean); and relationships writes (firefox, /home/admin/clean), executes (clean, /home/admin/clean).

By leveraging on such capabilities, an embodiment may obtain useful information for policy enforcement, as illustrated by the following examples:
file (/home/admin/clean) is a file; thus, any activity associated with it must be compliant to be allowed for such perimeter. In our Logical system, it is an entity represented by a constant.
firefox is a process; therefore, activities may be associated with an application perimeter. More complex reasoning rules can be determined to properly specify the perimeter, examples include:
   (Process, User) is an example of rule using FOL that can be used to determine perimeter boundaries for only specific users being able to execute a particular application; or
   [hasAccess (data, User), writes (Process,data)] may be used to specify boundaries that only particular users can access data of a particular process.

One embodiment operates to extract logical rules and form logical facts from Knowledge Graphs is using Ruleformer (as disclosed in [3]), which is a transformer-based rule mining approach that takes advantage of context information to extract suitable rules for different inference tasks. However, any other rule mining algorithm can be used to create the file containing policies given as input.

It is noted that it may be trivial, in one embodiment, to use logical rules to create such graphs. For example, once the environment is instantiated, it only requires iterating through the set of logical facts, creating nodes for the entities represented by the constants and using the predicate that connects them to add an edge between them. To illustrate, execute (Process, User) describes that an entity of type User can execute an entity of type Process. When instancing the new environment, that is, the target environment, an embodiment will have the two variables substituted for corresponding constants thais and firebox. This leads to execute (firefox, thais), resulting in a new node of type User for thais, and another of type Process for firefox. Both are connected by an edge of type execute.

### C.2.2 Policy Hot-Start Engine

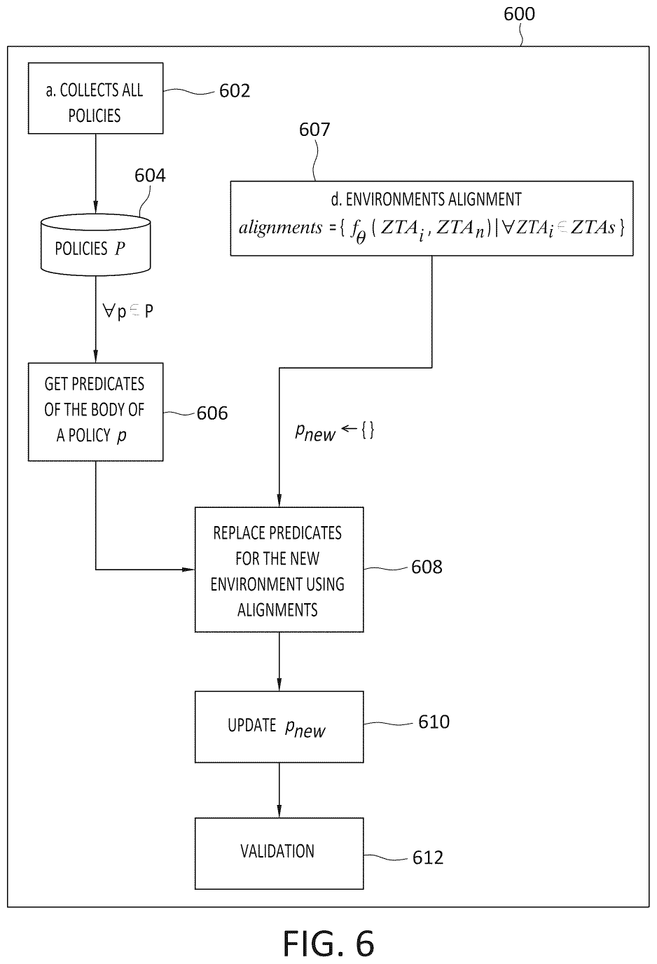

With reference now to FIG. 5, an example workflow 500 includes a policy hot-start engine 502 that receives parsed data from a data parsing operation/system 504, and then generates an initial set of policies 506. As shown, the policy hot-start engine 502 may comprise various components, including:
Environment Alignment: the environment alignment component 502a considers how to capture differences between the new environment with respect to existing environments. Even though enterprises might be different, working processes can be quite similar. Thus, environments might have entities, objects, and relationships in common. One embodiment may rely on graph alignment to find the corresponding entities of the new environment using previous architectures. Thus, an embodiment may operate to align each entity of the new, or target, environment to their corresponding entities in previous, or reference, environments.
Policy Generation: this component, when provided with environment mappings, combines alignments to their corresponding policies to provide initial policies for the new environment—to do this, the policy generation component 502b uses the set of policies given as input and works on replacing entities from one domain to another using environment mappings. Thus, an embodiment may generate new rules based on the new environment, as indicated in the fuller example disclosed in FIG. 6 and discussed below.

### C.2.2.1 Environment Alignment

With continued reference to the example of FIG. 5, and the environment alignment component 502a, an embodiment may employ a terminological and structural graph alignment algorithm to retrieve the similar entities and sub-structures between the new environment and the existing one. One possible application of an embodiment of a method is to Zero Trust Architectures (ZTAs), thus, for illustrative purposes, the present example assumes that the existing, or reference, environment, and the new, or target, environment, are both ZTAs.

Formally, given a set of existing ZTAs, ZTAs={ZTA₁, ZTA₂, . . . , ZTAₖ}, and a new ZTA ZTAₙ, where ZTAₙ∉ZTAs. Then let

$$alignments = \{ {f}_{θ} ( {ZTA}_{i} , {ZTA}_{n} ) \vert ∀ Z T {A}_{i} ∈ Z T A s \} ,$$

denote the resulting set of alignments, where f_{θ} is a graph alignment method such as described earlier herein. In case an entity or relation does not find a feasible mapping, it is mapped to empty. In an embodiment, the list of entities and relations may be provided to the user as information in order to improve the environment.

By approaching the problem this way, an embodiment comprises a scalable method which provides mappings between the new ZTA environment description, and the existing ZTA environments given as input. The result of such alignment is a subgraph of ZTAs environments since not all entities/relations can be mapped to other in a different context.

### C.2.2.2 Policy Generation

With continued reference to the policy generation component 502b in the example of FIG. 5, and referring now to FIG. 6, one example embodiment of a policy generation algorithm 600 is disclosed. By way of overview, the policy generation component 502b of a system creates a set of rules combining policies of the environments given as input. Then, the policy generation component 502b uses the alignments found in the last step, discussed above, so each entity and relation in such rules is replaced by its corresponding mapping in the new environment. In this way, all policies may be set up to the new environment. One example of how replacement takes place is discussed below in connection with FIG. 6. However, consider the policy hasEditingAccess(Name,Person):-application (Name), softwareDeveloper (Person). In this case, the predicates of the body are application and softwareDeveloper, while hasEditingAccess is the head of the rule. These predicates might be represented to their corresponding similar entities in the new environment. In this example, Name and Person are variables that are not replaced.

Continuing with the previous example using ZTAs, and turning now to a more detailed discussion of the example policy generation algorithm 600 of FIG. 6, let P denote the set of policies for every input ZTA, and M the set of mappings provided by the graph alignments, the algorithm 600 comprises various operations. Initially, the algorithm 600, or another algorithm, may collect 602 polices associated with respective reference environments, and store 604 those policies in a database.

A policy generation portion of the algorithm 600 may comprise the following operations:

```
1. For each pᵢ ∈ P;
2. Collect predicates 606 of the body of pᵢ by iterating through policies.
    This is performed as described earlier herein, and leads to obtaining
    a set of predicates of the body called predicates.
3. Replace the predicates 608 in p by their corresponding mappings in M
    according to the mappings found during alignment 607. This process
    may proceed as follows:
        a. Suppose predᵢ ∈ predicates originates from ZTAⱼ
        b. Let aⱼ ∈ M denote the alignment mapping ZTAⱼ to ZTAₙ computed
            as described earlier herein.
        $c . Then {pred}_{i}^{′} ← {a}_{j} ( {pred}_{i} ) .$
4. If p is not empty:
        a. Build a new policy with the original head of p and the body
            replaced by the mappings according to the new environment.
            In more detail:
                    $i . {p}_{i}^{′} ← head ( {p}_{i} ) : - {pred}_{i}$
        b. Insert 610 p′ᵢ to the new set of policies P_{new}.
5. Finally, a policy validation process, discussed in further detail below,
    may beperformed 612.
```

### C.2.2.3 Policy Validation and Enforcement

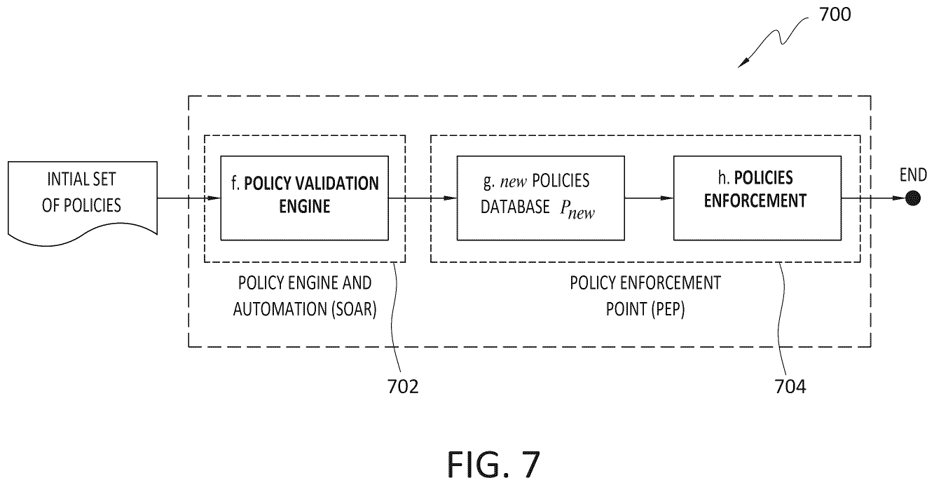

As disclosed herein, an embodiment provides an initial set of policies. Following is a discussion of various possible approaches for their usage. This includes policy validation and enforcement, for instance, and with reference to the example schema 700 in FIG. 7, by a Policy Validation Engine 702 and the Policy Enforcement Point 704.

In an embodiment, policies can be verified automatically by, for instance, a Prolog interpreter which will try to prove their truthiness by reasoning over other existing rules and facts of the new environment. Other verification mechanisms could also be implemented, such as SQL (structured query language) queries for relational databases, for example. In case of a query that could not be proven true, the set of policies is revised. However, a manual validation may be employed in an embodiment to enable a specialist to check on such policies to decide which ones are suitable for the new environment, and perform possible improvements before deployment.

As an embodiment may deal with policies from different reference environments, a system according to one embodiment may generate clauses, which may be redundant with each other in whole or in part, as a result of combining policies from different resources. Some literals of a clause are redundant as they are implied by other literals of the clause or by the rest of the set of policies. Checking, and eliminating, redundancy may be important to maintain a subset of clauses that is both equivalent to the original one, and irredundant.

For example, consider the three literals P(X, Y), P(Y, X) and Q(X, Y, A). These literals are combined to form the following clause: P(X, Y), P(Y,X):-Q(X, Y, A). Note that P(X, Y), P(Y, X) are redundant for this clause, such that any one of them can be removed. Another example is the clauses: P(X,Y):-Q(X,Y) and P(Y,X):-Q(Y,X). An irredundant equivalent subset is a subset of the original set and, in this case, one of the clauses can be removed from the set without causing damage.

### D. EXAMPLES

To provide an example of an embodiment of a method, consider a straightforward example where there is one cybersecurity system which is a Zero Trust Architecture (ZTA) governing a company access authentication system, and a new company has decided to implement a ZTA as well to guarantee a better authentication system for the new company.

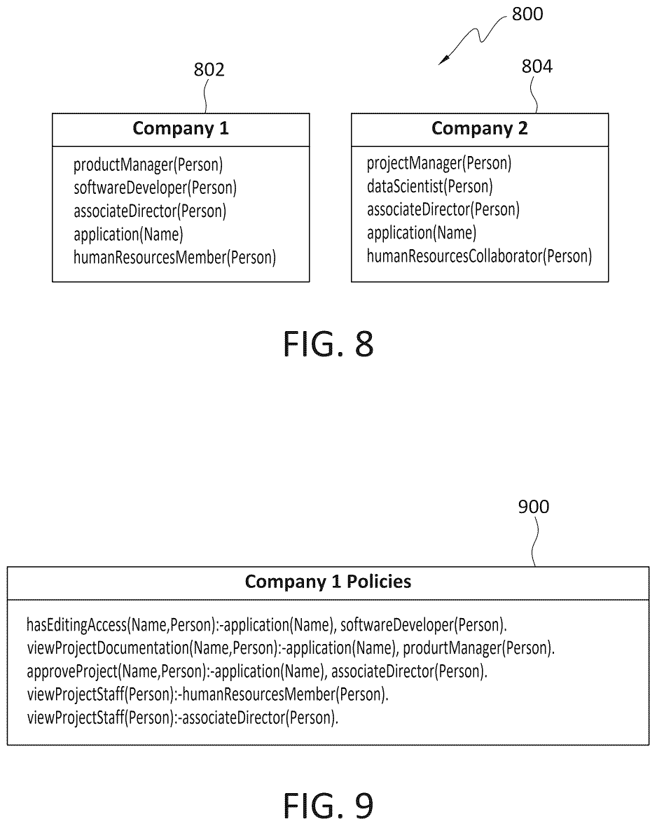

In this, non-limiting, example, and with reference to the example schema 800 of FIG. 8, a reference company 802 is part of the software industry and its ZTA environment contains information about system users, company departments that each user work on, and the applications that user must authenticate to have access. The new company 804 is a data analytics company and its ZTA environment also contains information about system users, company departments, and the applications to authenticate to get access. The descriptions of both companies are shown in FIG. 8, while FIG. 9 discloses example policies 900 applied by the company 802. In particular, FIG. 8 discloses an operational ZTA environment description (left) for the company 802, and the description of a new ZTA environment the company 804 for which policies are to be derived (right). FIG. 9 discloses the policies 900 implemented in the first company 802 which has a properly built ZTA environment that is to be adapted for use in the second company 804.

Given the two environments, for companies 802 and 804 respectively, presented in FIG. 8, the first step is to iterate through the policies 900 disclosed in FIG. 9, and collect every predicate used in those policies 900. Then, an embodiment of the system creates the following mappings after alignment:
associateDirector→associateDirector
   application→application
   projectManager→productManager
humanResourcesCollaborator→humanResourcesMember
   dataScientist→softwareDeveloper

Then, these mappings are applied to the set of rules presented in FIG. 9 to generate an initial set of policies which can then be implemented in the ZTA of the second company 804.

In particular, the following policies may be generated:
1. hasEditingAccess(Name,Person):-application(Name),dataScientist(Person).
2. viewProjectDocumentation(Name,Person):
   application(Name),projectManager(Person).
3. approveProject(Name, Person):
   application(Name),associateDirector(Person).
4. viewProjectStaff(Person):-humanResourcesCollaborator(Person).
5. viewProjectStaff(Person):-associateDirector(Person).

### E. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. FURTHER EXAMPLE EMBODIMENTS

Following are some further example embodiments. These are presented only by way of example and are not intended to limit the scope of this disclosure or the claims in any way.

Embodiment 1. A method for implementing a policy hot-start in an environment, comprising: receiving, as input, respective descriptions of reference environments, a respective set of reference operating policies for each of the reference environments, and a description of a target environment; using respective graphs to represent each of the reference environments; normalizing the reference operating policies in a normalized description form in which alignment operations can be applied; mapping from the reference environments to a target environment by applying a graph alignment technique to the graphs; and automatically generating a set of policies compatible with the description of the target environment by mapping the reference policies to the target environment.

Embodiment 2. The method as recited in any preceding embodiment, wherein the reference policies mapped to the target environment are subjected to a validation process.

Embodiment 3. The method as recited in any preceding embodiment, wherein one or more of the reference environments, and the target environment, comprise respective ZTAs (zero-trust architectures).

Embodiment 4. The method as recited in any preceding embodiment, wherein the graphs each comprise a respective KG (knowledge graph) in which network entities in the reference environment to which the KG applies are represented in the KG as respective nodes, and relationships between the nodes in the reference environment are represented in the KG as edges connecting the nodes.

Embodiment 5. The method as recited in any preceding embodiment, wherein the reference policies, and the set of policies that was automatically generated, comprise respective cybersecurity policies.

Embodiment 6. The method as recited in any preceding embodiment, wherein each of the reference policies, and policies in the set of policies, comprises a respective set of one or more rules.

Embodiment 7. The method as recited in any preceding embodiment, wherein an FOL (first-order logic) approach is used to render each of the reference operating policies into a normalized description form.

Embodiment 8. The method as recited in any preceding embodiment, wherein the mapping comprises determining an extent to which the reference environments are similar to the target environment.

Embodiment 9. The method as recited in any preceding embodiment, wherein the target environment is either a new environment, or a modified environment.

Embodiment 10. The method as recited in any preceding embodiment, wherein the graphs are generated based on the input.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

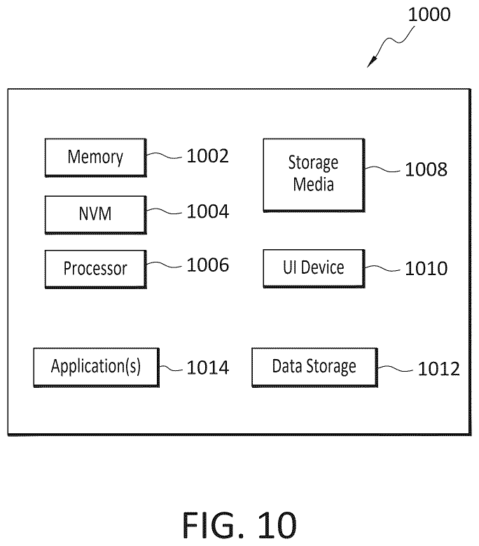

With reference briefly now to FIG. 10, any one or more of the entities disclosed, or implied, by FIGS. 1-9, and/or elsewhere herein, may take the form of, or include, or be implemented on, or hosted by, a physical computing device, one example of which is denoted at 1000. As well, where any of the aforementioned elements comprise or consist of a virtual machine (VM), that VM may constitute a virtualization of any combination of the physical components disclosed in FIG. 10.

In the example of FIG. 10, the physical computing device 1000 includes a memory 1002 which may include one, some, or all, of random access memory (RAM), non-volatile memory (NVM) 1004 such as NVRAM for example, read-only memory (ROM), and persistent memory, one or more hardware processors 1006, non-transitory storage media 1008, UI device 1010, and data storage 1012. One or more of the memory components 1002 of the physical computing device 1000 may take the form of solid state device (SSD) storage. As well, one or more applications 1014 may be provided that comprise instructions executable by one or more hardware processors 1006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope. cm What is claimed is:

1. A method for implementing a policy hot-start in an environment, comprising:
receiving, as input, respective descriptions of reference environments, a respective set of reference operating policies for each of the reference environments, and a description of a target environment;
using respective graphs to represent each of the reference environments;
normalizing the reference operating policies in a normalized description form in which alignment operations can be applied;
mapping from the reference environments to a target environment by applying a graph alignment technique to the graphs; and
automatically generating a set of policies compatible with the description of the target environment by mapping the reference policies to the target environment.

2. The method as recited in claim 1, wherein the reference policies mapped to the target environment are subjected to a validation process.

3. The method as recited in claim 1, wherein one or more of the reference environments, and the target environment, comprise respective ZTAs (zero-trust architectures).

4. The method as recited in claim 1, wherein the graphs each comprise a respective KG (knowledge graph) in which network entities in the reference environment to which the KG applies are represented in the KG as respective nodes, and relationships between the nodes in the reference environment are represented in the KG as edges connecting the nodes.

5. The method as recited in claim 1, wherein the reference policies, and the set of policies that was automatically generated, comprise respective cybersecurity policies.

6. The method as recited in claim 1, wherein each of the reference policies, and policies in the set of policies, comprises a respective set of one or more rules.

7. The method as recited in claim 1, wherein an FOL (first-order logic) approach is used to render each of the reference operating policies into a normalized description form.

8. The method as recited in claim 1, wherein the mapping comprises determining an extent to which the reference environments are similar to the target environment.

9. The method as recited in claim 1, wherein the target environment is either a new environment, or a modified environment.

10. The method as recited in claim 1, wherein the graphs are generated based on the input.

11. A non-transitory storage medium having stored therein instructions that are executable by one or more hardware processors to perform operations comprising:
receiving, as input, respective descriptions of reference environments, a respective set of reference operating policies for each of the reference environments, and a description of a target environment;
using respective graphs to represent each of the reference environments;
normalizing the reference operating policies in a normalized description form in which alignment operations can be applied;
mapping from the reference environments to a target environment by applying a graph alignment technique to the graphs; and
automatically generating a set of policies compatible with the description of the target environment by mapping the reference policies to the target environment.

12. The non-transitory storage medium as recited in claim 11, wherein the reference policies mapped to the target environment are subjected to a validation process.

13. The non-transitory storage medium as recited in claim 11, wherein one or more of the reference environments, and the target environment, comprise respective ZTAs (zero-trust architectures).

14. The non-transitory storage medium as recited in claim 11, wherein the graphs each comprise a respective KG (knowledge graph) in which network entities in the reference environment to which the KG applies are represented in the KG as respective nodes, and relationships between the nodes in the reference environment are represented in the KG as edges connecting the nodes.

15. The non-transitory storage medium as recited in claim 11, wherein the reference policies, and the set of policies that was automatically generated, comprise respective cybersecurity policies.

16. The non-transitory storage medium as recited in claim 11, wherein each of the reference policies, and policies in the set of policies, comprises a respective set of one or more rules.

17. The non-transitory storage medium as recited in claim 11, wherein an FOL (first-order logic) approach is used to render each of the reference operating policies into a normalized description form.

18. The non-transitory storage medium as recited in claim 11, wherein the mapping comprises determining an extent to which the reference environments are similar to the target environment.

19. The non-transitory storage medium as recited in claim 11, wherein the target environment is either a new environment, or a modified environment.

20. The non-transitory storage medium as recited in claim 11, wherein the graphs are generated based on the input.
